(19) United States
(12) Patent Application Publication
(10) Pub. No.: US 2006/0169712 A1
(43) Pub. Date: Aug. 3, 2006

(54) RIMMED CUP DISPENSER

(76) Inventor: Yitzchak Yitzchaki, Pardessiay (IL)

Correspondence Address: Yitzchak Yitchaki, 47 Hasavyon St., Pardessiay, IL

(21) Appl. No.: 11/162,656

(22) Filed: Sep. 19, 2005

(30) Foreign Application Priority Data
Feb. 3, 2005 (IL) 167206

(51) Int. Cl. G07F 11/16; B65H 3/28

(52) U.S. Cl. 221/221; 221/297

(57) ABSTRACT

A cup dispenser and process of using the cup dispenser are disclosed. The dispenser releases cups, one-by-one, from the bottom of a stack of cups seated one within the other and frictionally engaged to each other, the cups having a top rim. The apparatus comprises a cups carrier structure (10) adapted to be affixed to a generally vertical stationary support; and, an operator member (22) of generally planar configuration adapted to perform a reciprocating sliding movement within the cups carrier structure between extracted and inserted positions for releasing the cups one at a time. The operator member is the component that separates the bottom cup from the stack above and then dispenses it below. The operating member has two arm-like projections (30) and (28) generally parallel to each other and forming a hollow between them where the cups reside. Each arm-like projection comprises three sections in longitudinal succession relative to each other. The first section (32 or 32′) supports one side of a cup by the rim of a cup and wedges between the rims of two cups in the stack. The second section (34 or 34′) is a recessed portion that allows a cup to pass through the hollow. The third section (36 or 36′) is an arched extension to support one side of a cup by the rim (B) and so that each arm-like portion support the bottom cup in a stack of cups on by diametrically opposite sides of the cup. The process of using the cup dispenser involves pushing a button to slide the operator member to the inserted position and taking the dispensed cup.

### CROSS-REFERENCE TO RELATED APPLICATIONS

The foreign priority application number 167206 for this invention, having the title “MANUALLY OPERATED CUPS DISPENSER APPARATUS” and filed on Feb. 3, 2005 in Israel, is hereby incorporated by reference.

### FIELD OF THE INVENTION

The invention concerns cups dispensers as used in connection with beverage dispensers for offices, clinics and the like, particularly water coolers and specifically including dispensers which segregate cups from a stacked supply by the alternate interposition and removal of means in the path of normal gravitational movement of the cups.

### BACKGROUND OF THE INVENTION

Known cups dispensers comprise a hopper for a stack of cups seated one over the other. The lowermost cup is exposed from the bottom of the stack, held by its rim against a pair of springy clips or pawls. Removal of a cup for use is achieved by pulling downwards at the lower part of the cup by a force sufficient to overcome the arrested position, by spreading apart the pawls and/or partly deforming the rim of the cups.

Since the cups are normally made of very thin plastic material, it often happens that two or more cups become extracted; moreover, the force required for detaching the cups is usually beyond the capability of small children.

It is therefore the general object of the present invention to overcome the above listed deficiencies of the conventional dispensers. It is a further object of the invention to provide a more efficient and friendly mode of use of cups dispensers. It is a still further object of the invention to effect the cup dispensing by a simple push-button operation.

### SUMMARY OF THE INVENTION

The invention is a cup dispenser and process of using the cup dispenser. The dispenser releases cups, one-by-one, from the bottom of a stack of cups seated one within the other and frictionally engaged to each other, the cups having a top rim. The apparatus comprises a cups carrier structure adapted to be affixed to an approximately vertical stationary support; and, an operator member of generally planar configuration adapted to perform a reciprocating sliding movement within the cups carrier structure between extracted and inserted positions for releasing the cups one at a time. The operator member is the component that separates the bottom cup from the stack above and then dispenses it below. The operating member has two arm-like projections generally parallel to each other and forming a hollow between them where the cups reside. Each arm-like projection comprises three sections in longitudinal succession relative to each other. The first section supports one side of a cup by the rim of a cup and wedges between the rims of two cups in the stack. The second section is a recessed portion that allows a cup to pass through the hollow. The third section is an arched extension to support one side of a cup by the rim and so that each arm-like portion supports the bottom cup in a stack of cups on by diametrically opposite sides of the cup. The process of using the cup dispenser involves pushing a button to slide the operator member to the inserted position and taking the dispensed cup.

### BRIEF DESCRIPTION OF THE DRAWINGS

These and additional constructional features and advantages of the invention will be more readily understood in the light of the ensuing description of a preferred embodiment thereof, given by way of example only, with reference to the accompanying drawings.

FIG. 1 is a schematic side view of the cup dispenser apparatus according to a preferred embodiment of the present invention.

FIG. 2 is a sectional view taken along line II-II of FIG. 1 showing the operator member in the extracted position.

FIG. 3 is a sectional view taken along line III-III of FIG. 2.

FIG. 4 is a sectional view taken along line IV-IV of FIG. 3.

FIG. 5 is a perspective view of the operator member.

FIG. 6 is similar to FIG. 2, except that it shows the operator member in the inserted position.

FIG. 7 is a sectional view of FIG. 6.

FIG. 8 is a sectional view of FIG. 7.

### DETAILED DESCRIPTION OF THE PREFERRED EMBODIMENT

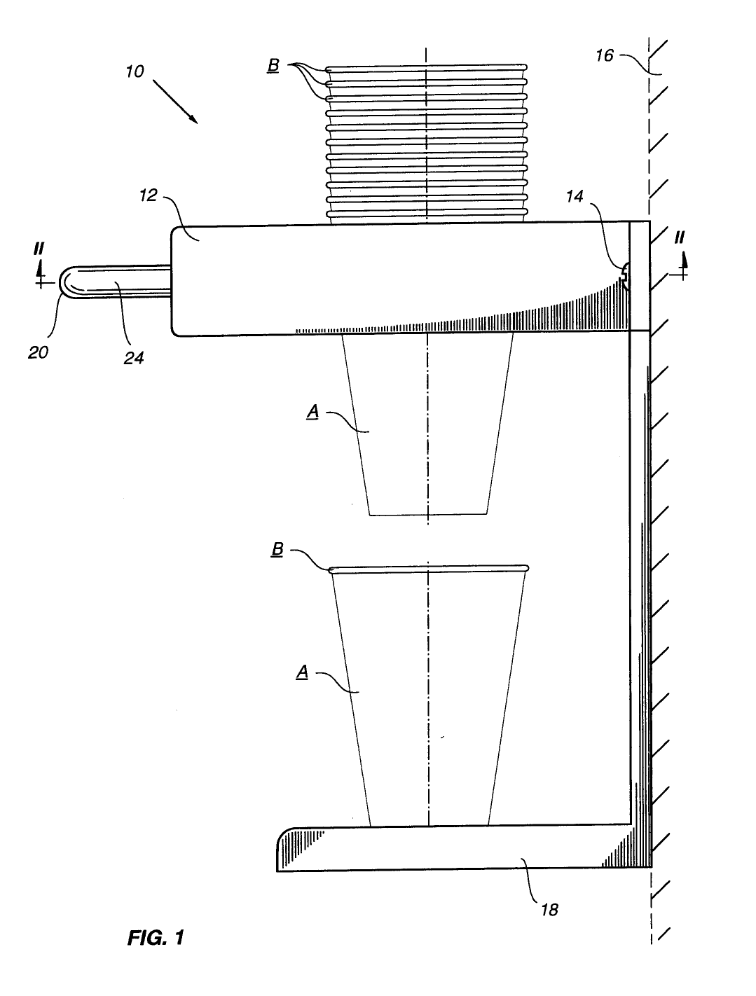

As shown in FIG. 1, the cups carrier or hopper structure of the dispenser apparatus is generally denoted (10) is in the form of console (12) mounted, e.g. by bolts (14), to a generally vertical support (16), normally a wall or the body of a water cooler (not shown).

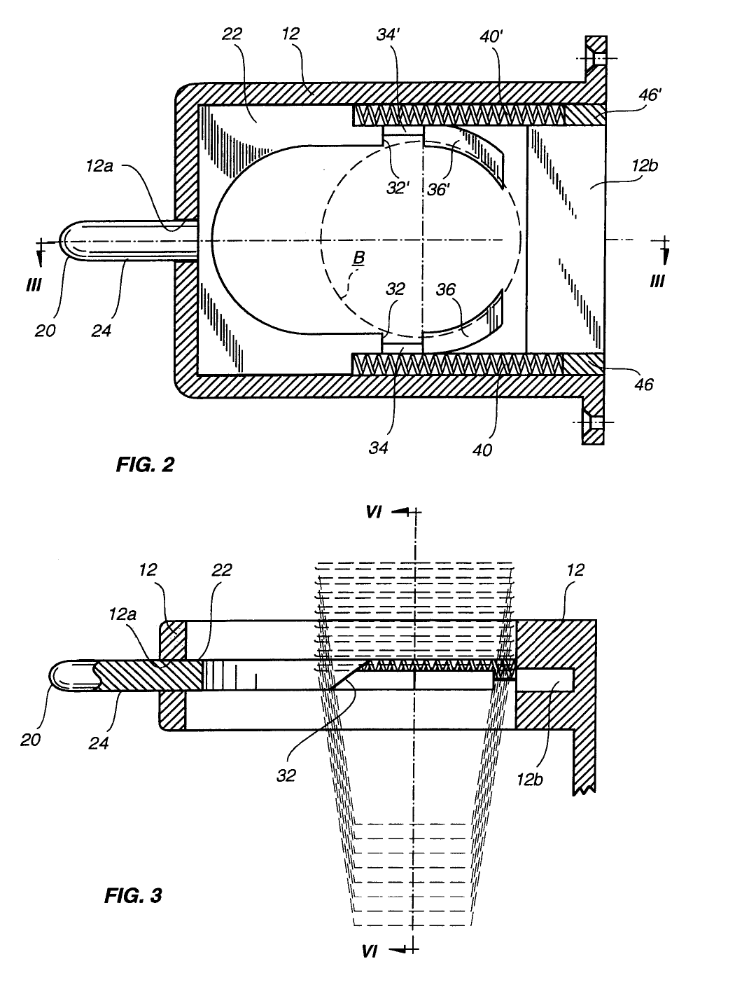

In the preferred embodiment, the console (12) is part-and-parcel of a unit, which also comprises a lower tray (18) for receiving cups (A), which are to be detached, one by one (see below), from a stock of cups piled one within the other. The cups are typically cone-shaped, but may be any shape, each cup provided with a rim (B). Releasing of the lowermost cup from the stack of cups is effected by pushing a button (20), which locates the operator member (22), shown in FIG. 2, to the inserted position.

In an alternative embodiment, the lower tray is a downwardly extending portion of the cups carrier structure (10) configured to receive a dispensed cup in arms fitting under the rim (B) of said dispensed cups.

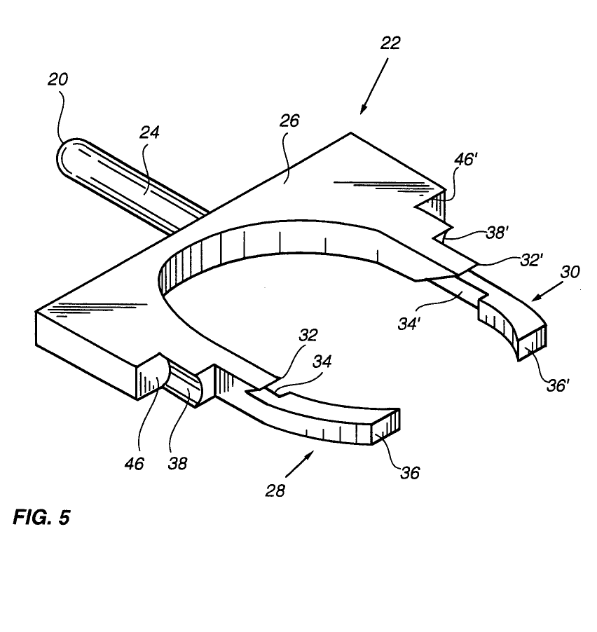

Referring to FIGS. 2-5, the configuration and manner of operation of the preferred embodiment is further described. FIG. 5 shows an operator member (22) of generally planar configuration, which performs a reciprocating sliding movement within the cups carrier structure operating between extracted and inserted positions for releasing the cups, one at a time. The operator member (22) has two arm-like portions (28) and (30) generally parallel to each other forming a hollow defined between the two arms.

Each arm-like portion of the operator member comprises three sections or portions in longitudinal succession relative to each other. The two arm-like portions are generally of mirror image configuration. The first section, or wedge section, (32 or 32′) of an arm-like portion (28 or 30, respectively) is configured to support one side of a cup by the rim of a cup and further configured to wedge between the rims of two cups piled one within the other for releasing the frictional grip between the two cups. The two wedge sections (32 and 32′) together generally operate on the rims at diametrically opposite parts of the cups. The second section, or recessed section (34 or 34′) is configured so that together the recess portion on each side allows a cup to pass through the hollow. The third section, or arched extension, (36 or 36′) is configured to support one side of a cup by the rim of a cup so that the two arched extensions together support the bottom cup in a stack of cups on by diametrically opposite sides of the cup.

The operator member (22) is preferably integrally formed by plastic injection molding; it comprises a button (20) at the end of push rod (24) annexed to flat portion (26), from which a pair of arms (28 and 30) extend, being identical, but of mirror-image configuration.

In an alternative embodiment, cups are released by an electric motor operably connected for driving said planar operator member (22) inward to the inserted position in response to an activating electrical signal. The electric motor takes the place of manual activation of the apparatus by pushing the button (20) at the end of the push rod (24). The electrical signal is typically activated by touch sensitive button or switch electrically connected to the motor.

As will be more clearly understood in view of FIG. 2, the distance between the wedged portions (32 and 32′) conforms the diameter of the cups immediately under the rim (B); the distance between the recessed portions (34 and 34′) is greater than the diameter of the rim (B); and the distance between the arched extensions (36 and 36′) is again smaller than the diameter of the rim (B) to enable partly embracement of a cup (actually, the stack of cups) in the suspended state.

The operator member (22) further comprises a pair of concave portions (38), (38′) serving to guide coil-springs (40), (40′) as will be described further below.

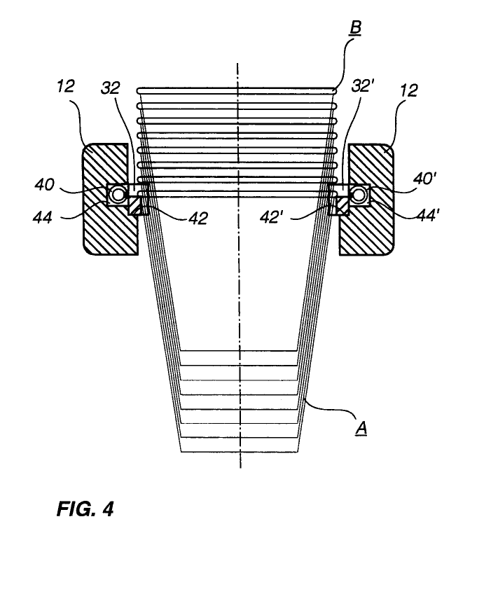

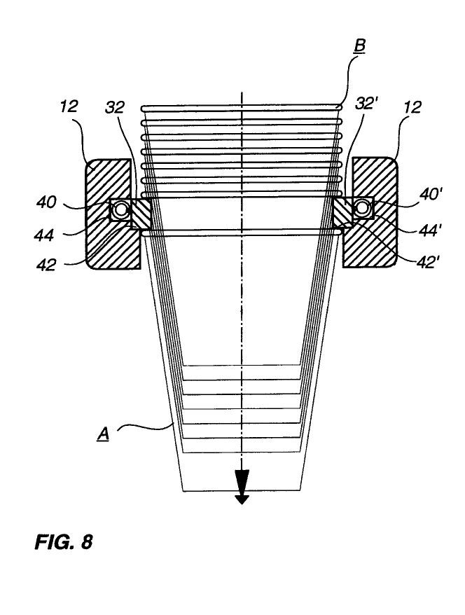

The operator member (22) is adapted to slide back-and-forth within the console (12) of the cups carrier structure (10), being supported on step-like rails (42), (42′) (see FIGS. 4 and 8), and further by bore (12a) at the front side, and cavity (12b) at the back side the console (12) (the later only during the last stage of the dispensing operation—see FIG. 7).

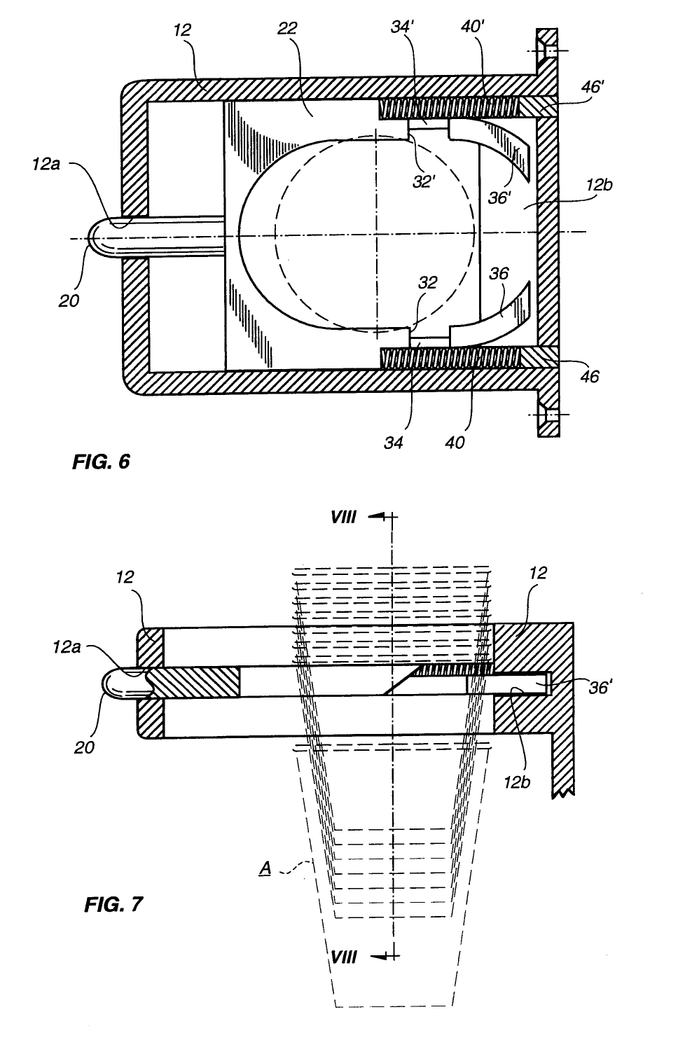

As shown in FIG. 4, the above-mentioned springs (40), (40′) are nested within longitudinal channels formed by slots (44), (44′), together with the concave sections (38), 38′. Referring to FIG. 5, the springs are squeezed between shoulders (46), (46′) and plugs (46), (46′) inserted from the back side as seen in FIGS. 2 and 6, thus completing the assembly of the cups carrier structure (10).

The operation of the cups carrier structure (10) is described with further reference to FIGS. 6-8. Having the cups carrier structure (10) affixed to the wall (16), a stack of cups (A) is placed as shown in FIGS. 1 and 3. The stack remains suspended since the rim (B) of the lowermost cup rests on the extensions (36) and (36′) whereby the major portion of the lowermost cup bulges from below.

Sliding the operator member (22), using the button (20) will, sequentially, bring the wedge portions (32 and 32′) below the rim (B) of next-in-line cup, while the lower cup becomes released from between the extensions (36), (36′). The stack of cups therefore remains in suspension and does not fall down through the gap between the portions (34) and (34′) while the lowermost cup, having been released from the frictional grip of the adjacent upper cup, will free-fall into the tray (18), ready to be taken for service.

When allowed to withdraw under the force of the springs (40), (40′), the wedge portion retracts from below the rim (B) of the now lowermost cup, which immediately thereafter becomes engaged by the extensions (36), (36′). This completes the operational cycle of cups dispensing. Therefore, a preferred method of using the preferred embodiment of the invention is both affixed to a generally vertical stationary support and loaded with cups to be dispensed, comprises the steps of, sliding the operator member to the inserted position; and, taking the dispensed cup.

It will be thus readily appreciated that the cups dispenser proposed according to the present invention effectively overcomes the disadvantages of the conventional devices while still being simple and relatively inexpensive to manufacture.

Those skilled in the art to which this invention pertains will readily appreciate that numerous changes, variations and modifications can be effectuated without departing from the true spirit and scope of the invention as defined in and by the appended claims.

What is claimed is:

1. A dispenser apparatus for releasing cups, one-by-one, from the bottom of a stack of cups seated one within the other and frictionally engaged to each other, the cups having a top rim, the apparatus comprising,
(a) a cups carrier structure adapted to be affixed to a generally vertical stationary support; and,
(b) an operator member of generally planar configuration adapted to perform a reciprocating sliding movement within the cups carrier structure between extracted and inserted positions for releasing the cups one at a time, said operator member comprising two arm-like portions generally parallel to each other and forming a hollow defined therebetween, wherein each arm-like portion comprises three sections in longitudinal succession relative to each other, (i) a first section configured to support one side of a cup by the rim of a cup and further configured to wedge between the rims of two cups piled one within the other for releasing the frictional grip between the two cups; (ii) a second section configured so that a recess portion on each arm-like portion allows a cup to pass through the hollow; and (iii) a third section configured as an arched extension to support one side of a cup by the rim and so that each arm-like portion supports the cup at diametrically opposite sides of the cup.

2. The apparatus of claim 1 further comprising an electric motor operably connected for driving said planar operator member inward to the inserted position in response to an activating electrical signal.

3. The apparatus of claim 1 wherein the operator member is constantly spring urged into the extracted position thereof.

4. The apparatus of claim 3 further comprising a pair of coil springs located alongside the operator member.

5. The apparatus of claim 4 wherein the operator member is associated with a button by which the said reciprocating movement is attained.

6. The apparatus of claim 5 wherein the button and the operator member are integrally formed by plastic injection process.

7. The apparatus of claim 1 wherein the cups carrier structure further comprises a downwardly extending portion configured to receive a dispensed cup in arms fitting under the rim of said dispensed cup.

8. A method of using the apparatus of claim 1, the apparatus being both affixed to a generally vertical stationary support and loaded with cups to be dispensed, comprising the steps of, sliding the operator member to the inserted position; and, taking the dispensed cup.
